(19) United States
(12) Patent Application Publication
(10) Pub. No.: US 2012/0052349 A1
(43) Pub. Date: Mar. 1, 2012

(54) Rechargeable battery

(76) Inventors: Sung-Bae Kim, Yongin-si (KR); Sang-Won Byun, Yongin-si (KR)

(21) Appl. No.: 12/929,280

(22) Filed: Jan. 12, 2011

(30) Foreign Application Priority Data
Aug. 31, 2010 (KR) 10-2010-0084838

(51) Int. Cl. H01M 10/02

(52) U.S. Cl. 429/94; 429/160

(57) ABSTRACT

A rechargeable battery including a plurality of electrode assemblies; a case accommodating the plurality of electrode assemblies, the case having an opening; a cap assembly coupled to the opening to seal the case; one or more electrode terminals electrically connected to the electrode assemblies; and a lower insulating member coupled to the one or more electrode terminals and installed in the case, wherein the lower insulating member includes a first portion fixed to the electrode terminal, the first portion having a first width, and a second portion extending from one end of the first portion, the second portion having a second width, and a width-direction end of the second portion lies in a plane between an inner surface of the case and a center of a top surface of an outermost electrode assembly among the electrode assemblies, the top surface facing the second portion.

### BACKGROUND

1. Field

Embodiments relate to a rechargeable battery.

2. Description of the Related Art

Rechargeable batteries may be repeatedly charged and discharged, unlike primary batteries, which cannot be repeatedly charged. Low-capacity rechargeable batteries may be used for portable compact electronic apparatuses, e.g., mobile phones, notebook computers, and/or camcorders. High-capacity rechargeable batteries may be used as a power source for, e.g., driving a motor of a hybrid vehicle, etc. or high-capacity storage devices.

Recently, a high-output rechargeable battery using a non-aqueous electrolytic solution having high energy density has been developed. The high-output rechargeable battery may be configured as a high-capacity battery module by connecting a plurality of rechargeable batteries in series so as to be used for driving a motor for an apparatus requiring a large power, e.g., an electrical vehicle, etc. The rechargeable battery may have, e.g., a cylindrical shape, an angular shape, and the like.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery.

At least one of the above and other features and advantages may be realized by providing a rechargeable battery including a plurality of electrode assemblies; a case accommodating the plurality of electrode assemblies, the case having an opening; a cap assembly coupled to the opening to seal the case; one or more electrode terminals electrically connected to the electrode assemblies; and a lower insulating member coupled to the one or more electrode terminals and installed in the case, wherein the lower insulating member includes a first portion fixed to the electrode terminal, the first portion having a first width, and a second portion extending from one end of the first portion, the second portion having a second width, and a width-direction end of the second portion lies in a plane between an inner surface of the case and a center of a top surface of an outermost electrode assembly among the electrode assemblies, the top surface facing the second portion.

The top surface of the electrode assembly facing the second portion of the lower insulating member may include a curved portion.

The second width of the second portion may be about equal to a width of the cap plate.

The second width of the second portion may be larger than the first width.

The second portion may include an edge facing the electrode assembly, the edge including an inclined surface.

The inclined surface of the edge of the second portion may be a rounded-inclined surface.

The inclined surface of the edge of the second portion may be a flat-inclined surface.

The lower insulating member may include a first fixation protrusion on a surface of the first portion, the first fixation protrusion facing the cap assembly; and a second fixation protrusion on a surface of the second portion, the second fixation protrusion facing the cap assembly.

The rechargeable battery may further include a protection member covering a portion of an outside of the electrode assembly, the portion of the outside of the electrode assembly corresponding to the lower insulating member.

The protection member may be a tape covering the outside of the electrode assembly.

The lower insulating member may be made of an elastic material.

The one or more electrode terminals may be electrically connected to the electrode assemblies through an electrode current collecting member.

The electrode current collecting member may include a terminal junction portion, the terminal junction portion being electrically connected to the one or more electrode terminals.

The electrode current collecting member may include at least one tab branch, the at least one tab branch being electrically connected to at least one of the plurality of electrode assemblies and the terminal junction portion.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a rechargeable battery according to an embodiment.

FIG. 2 illustrates a cross-sectional view taken along line II-II of FIG. 1.

FIG. 3 illustrates a partial exploded perspective view of the rechargeable battery of FIG. 1.

FIG. 4 illustrates a cross-sectional view taken along line IV-IV of FIG. 3.

FIG. 5 illustrates a cross-sectional view taken along line V-V of FIG. 2.

FIG. 6 illustrates a cross-sectional view of a modified example of the rechargeable battery of FIG. 1.

FIG. 7 illustrates a partial exploded perspective view of a rechargeable battery according to another embodiment.

FIG. 8 illustrates a cross-sectional view taken along line VIII-VIII of FIG. 7.

### DETAILED DESCRIPTION

Korean Patent Application No. 10-2010-0084838, filed on Aug. 31, 2010, in the Korean Intellectual Property Office, and entitled: “Rechargeable Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

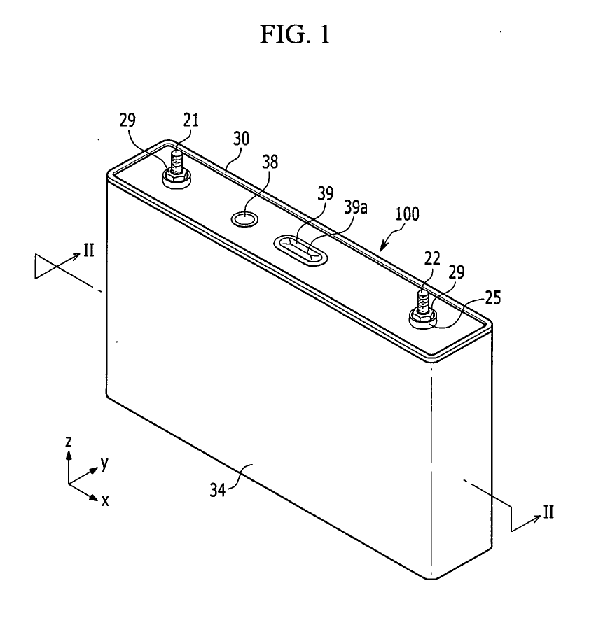

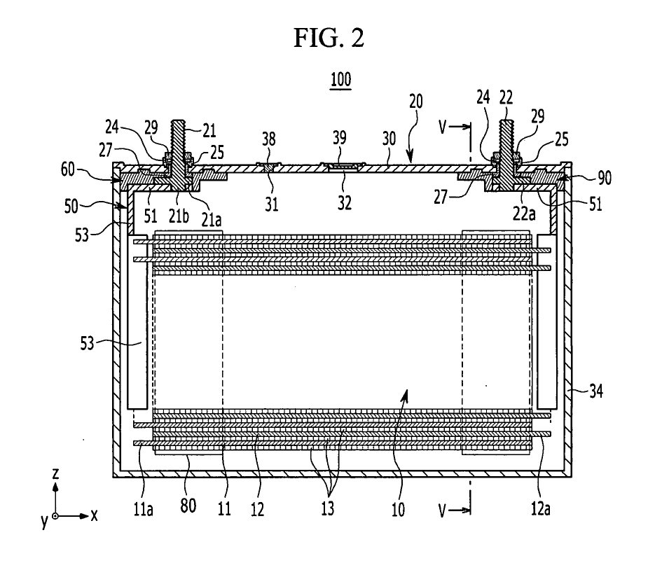

FIG. 1 illustrates a perspective view of a rechargeable battery according to an embodiment. FIG. 2 illustrates a cross-sectional view taken along line II-II of FIG. 1.

Referring to FIGS. 1 and 2, the rechargeable battery 100 according to the present embodiment may include a plurality of electrode assemblies 10 including a winding of a separator 13 interposed between a first electrode 11 and a second electrode 12, a case 34, a cap plate 30 with a discharge hole 32, a vent plate 39 coupled to one end of the discharge hole 32, and lower insulating members 60 and 90 installed in the case 34.

In an implementation, the rechargeable battery 100 may be a lithium ion rechargeable battery and may have an angular shape. However, the embodiments are not limited thereto and may be applied to other types of batteries, e.g., a lithium polymer battery, and the like. In an implementation, the first electrode 11 may be a negative electrode; and the second electrode 12 may be a positive electrode. In another implementation, however, the first electrode 11 may be the positive electrode; and the second electrode 12 may be the negative electrode. Here, for better comprehension and ease of description, the first electrode 11 and the second electrode 12 will be described instead of the negative electrode and the positive electrode.

The electrode assembly 10 may have a jelly roll shape formed by winding the first electrode 11, the second electrode 12, and the separator 13 together. The first electrode 11 and the second electrode 12 may include current collectors that are each formed of a thin-film metal foil with an active material coated on a surface of each current collector. The first electrode 11 and the second electrode 12 may include a coated region where the current collector is coated with the active material and uncoated regions 11a and 12a where the current collector is not coated with the active material. The coated region may occupy most of the first electrode 11 and the second electrode 12 in the electrode assembly 10 and the uncoated regions 11a and 12a may be disposed at sides of the coated region in a jelly roll state.

However, the embodiments not limited thereto; and the electrode assembly 10 may have a structure in which the first electrode 11 and the second electrode 12 include a plurality of sheets stacked with the separator 13 interposed therebetween.

The case 34 may have a substantially rectangular parallelepiped shape and may have an opening on one surface or end thereof. The cap assembly 20 may include a cap plate 30 covering the opening of the case 34, a first electrode terminal 21 protruding outwardly from the cap plate 30 and electrically connected with the first electrode 11, a second electrode terminal 22 protruding outwardly from the cap plate 30 and electrically connected with the second electrode 12, and a vent plate 39 with a notch 39a configured to open in response to a predetermined internal pressure.

The cap plate 30 may be formed of a thin plate material and may be coupled to the opening of the case 34 to seal the opening. The cap plate 30 may block an inside of the sealed case 34 from an outside thereof. Further, the cap plate 30 may connect the inside and the outside of the sealed case to each other. For example, the cap plate 30 may have an electrolytic solution inlet 31 for injecting an electrolytic solution into the sealed case 34. The electrolytic solution inlet 31 may be sealed by a sealing plug 38 after the electrolytic solution is injected.

The terminals 21 and 22 may penetrate the cap plate 30. For example, a first gasket 25 positioned in an upper part and a second gasket 27 positioned in a lower part between the cap plate 30 and the terminals 21 and 22 may insulate the cap plate 30 and the terminals 21 and 22 from each other. The terminals 21 and 22 include the first electrode terminal 21 and the second electrode terminal 22.

The terminals 21 and 22 may have a cylindrical shape. Nuts 29 supporting the terminals 21 and 22 on the top may be installed at the terminals 21 and 22; and threads may be formed on outer peripheries of the terminals 21 and 22 so that the nuts 29 may be fastened to the terminals 21 and 22. Terminal flanges 21a and 22a supporting the terminals on the bottom may be formed on the bottoms of the terminals 21 and 22. When the nuts 29 are fastened to the terminals 21 and 22, the terminal flanges 21a and 22a and the nuts 29 may press the first gasket 25 and the second gasket 27 to seal a space between the terminals 21 and 22 and the cap plate 30. Washers 24 for absorbing the fastening force of the nuts 29 may be installed below the nut 29.

In an implementation, the terminals 21 and 22 may not be cylindrical, but may instead be flat panel type terminals (not shown) coupled by terminals plates and rivets.

The lower insulating member 60 may be positioned adjacent to the cap plate 30 in the case 34. The first electrode terminal 21 may penetrate the lower insulating member 60.

Further, a protection member 80 covering a portion of an outside of the electrode assembly 10 corresponding to the lower insulating member 60 may surround the electrode assembly 10. In an implementation, the protection member 80 may be a tape that covers the electrode assembly 10. Accordingly, even if the electrode assembly 10 is deformed due to, e.g., external impact, and the like, damage to the electrode assembly 10 may be prevented. In an implementation, the tape may be made of an insulating material.

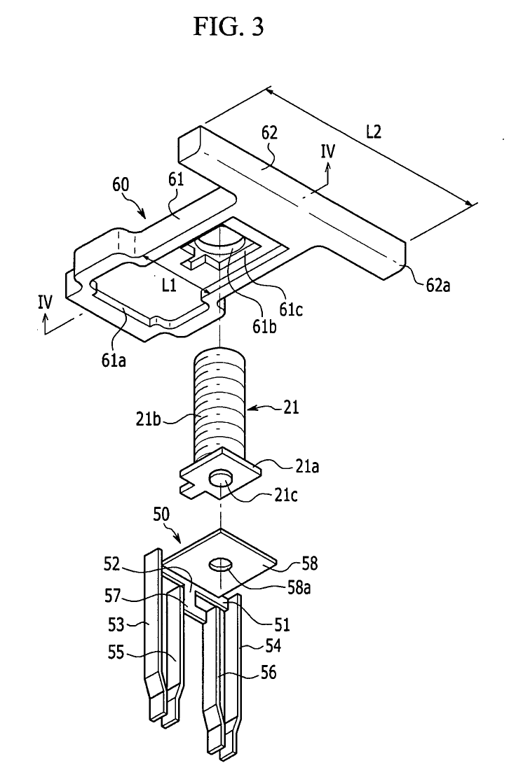

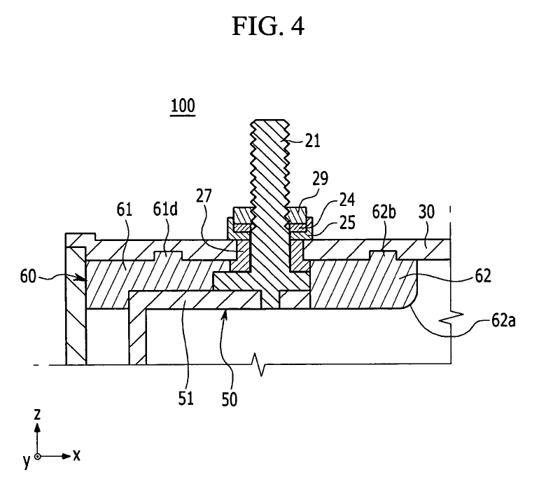

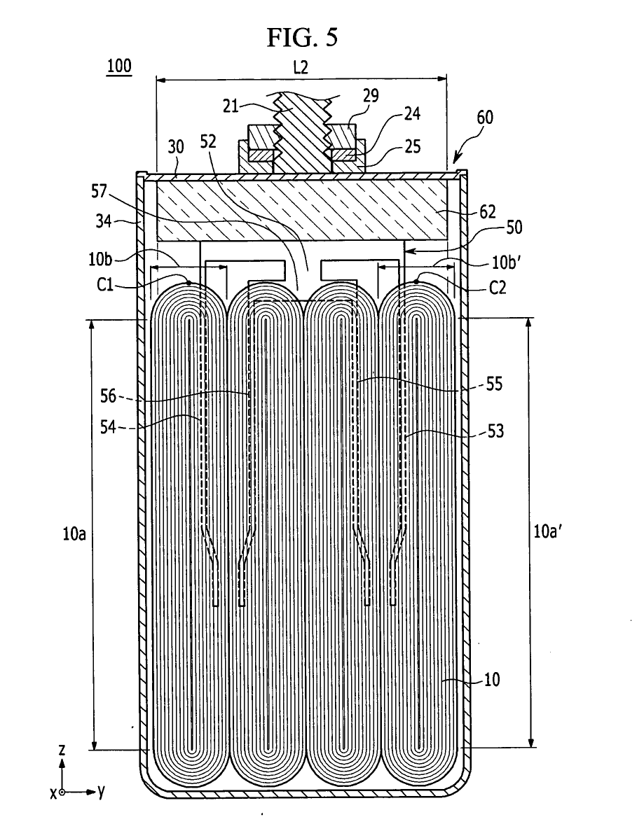

FIG. 3 illustrates a partial exploded perspective view of the rechargeable battery 100 of FIG. 1. FIG. 4 illustrates a cross-sectional view taken along line IV-IV of FIG. 3. FIG. 5 illustrates a cross-sectional view taken along line V-V of FIG. 2. Referring to FIGS. 3, 4, and 5, the rechargeable battery 100 according to the present embodiment will be described in more detail.

In an implementation, the rechargeable battery 100 may include a plurality of electrode assemblies, e.g., four electrode assemblies 10, and the four, electrode assemblies 10 may be stacked and arranged in parallel. Herein, the present embodiment will be described as including four stacked electrode assemblies 10.

As shown in FIG. 3, the first electrode terminal 21 may include a terminal pole 21b protruding from a terminal flange 21a. The first electrode terminal 21 may include the outer peripheral surface that is thread-processed as well as a supporting protrusion 21c that protrudes toward a bottom of the case 34 from a bottom of the terminal flange 21a.

A first electrode current collecting member 50 may include a terminal junction portion 58 with a support hole 58a into which the supporting protrusion 21c of the first electrode terminal 21 may be inserted as well as a plurality of branches 53, 54, 55, and 56 that extend below the terminal junction portion 58 and that may be inserted between the electrode assemblies 10. The terminal junction portion 58 may have a plate shape substantially parallel to the cap plate 30. A first basin portion 51 protruding outwardly further than a side end of the terminal junction portion 58 and bent toward a bottom of the terminal junction portion 58 may be below the terminal junction portion 58.

A first tab branch 53 and a second tab branch 54 may be bent on ends of the first basin portion 51 and may extend toward a bottom of case 34.

The first electrode current collecting member 50 may include connection plate 52 that extends downwardly toward the bottom of the case 34 from a center of the first basin portion 51. A second basin portion 57 protruding outwardly further than the side end of the connection plate 52 may be below the connection plate 52. The first electrode current collecting member 50 may include a third tab branch 55 and a fourth tab branch 56 bent toward a center of the electrode assembly 10 at side ends of the second basin portion 57 and extending toward the bottom of the case 34 from the second basin portion 57.

In an implementation, the connection plate 52 may be between the first tab branch 53 and the second tab branch 54. Accordingly, the third tab branch 55 and the fourth tab branch 56 may be between the first tab branch 53 and the second tab branch 54.

As a result, the uncoated regions having a thickness smaller than the coated region where the active material is coated may be formed on ends of each of the, e.g., four electrode assemblies 10 that are overlapped with or stacked against each other. Thus, a separated space may be formed between the first electrode uncoated regions 11a; and the tab branches 53, 54, 55, and 56 may be inserted into the space.

A shape of the first electrode current collecting member 50 is described as one example and may be changed as long as it is capable of performing a current collecting function. Therefore, the embodiments are not limited to the described examples.

The lower insulating member 60 may include a first portion 61 fixed to the first electrode terminal 21 and a second portion 62 extending from the first portion 61. The first portion 61 may be between sidewalls of the case 34 and the first electrode terminal 21. The second portion may be between the first electrode terminal 21 and a central region of the case 34, i.e., away from the sidewalls of the case 34. In an implementation, the lower insulating member 60 may be made of an insulating material and/or may be made of an elastic material.

In the present embodiment, a structure of the lower insulating member 60 fixed to the first electrode terminal 21 may be the same as that of the lower insulating member 90 fixed to the second electrode terminal 22. Thus, a repeated description of the lower insulating member 90 fixed to the second electrode terminal 22 will be omitted.

The first portion 61 of the lower insulating member 60 may have a first width L1 in a direction parallel to a surface of the cap plate 30. Further, as shown in FIG. 3, the first portion 61 may include a terminal hole 61b and a flange groove 61c at one portion thereof, e.g., corresponding to the terminal hole 21b, and a junction groove 61a on a surface of the lower insulating member 60 facing the first current collecting member 50 and the case 34.

For example, when the first electrode terminal 21 is inserted into the terminal hole 61b, the terminal flange 21a may be fixed to the flange groove 61c. Thus, when the first basin portion 51 of the first electrode current collecting member 50 is inserted into the junction groove 61a, the supporting protrusion 21c may be inserted into the support hole 58a and joined, e.g., welded.

Accordingly, the first portion 61 of the lower insulating member 60 may insulate the cap plate 30 and the first electrode current collecting member 50 from each other and may stably fix a position of the lower insulating member 60, e.g., in the case 34.

As illustrated in FIG. 4, a first fixation protrusion 61d may be on a surface of the first portion 61 that faces the cap plate 30. Accordingly, the first fixation protrusion 61d may be coupled to a fixation groove in the cap plate 30 to prevent the lower insulating member 60 from being rotated. A second portion 62 of the lower insulating member 60 may extend from a side of the lower insulating member 60, e.g., away from the first electrode terminal 21 and the sidewalls of the case 34, as shown in FIG. 3.

For example, the second portion 62 of the lower insulating member 60 may have a second width L2 in a direction parallel to the cap plate 30. As illustrated in FIG. 4, a second fixation protrusion 62b may be on a surface of the second portion 62 facing the cap plate 30 and may be coupled to a fixation groove in the cap plate 30 to prevent the lower insulating member 60 from being rotated.

Referring to FIG. 5, the second portion 62 may have the second width L2. Thus, width-direction ends of the second portion 62 may lie in a plane between an inner surface of the case 34 and centers C1 and C2 of top surfaces of outermost electrode assemblies 10 of the stack, e.g., surfaces facing the second portion 62.

For example, the width-direction ends of the second portion 62 may lie in a plane between side surfaces 10a and 10′a of the outermost electrode assemblies 10 and the centers C1 and C2 of curved, e.g., top, surfaces 10b and 10′b of the outermost electrode assemblies 10. In an implementation, the second width L2 may be about equal to a width of the cap plate 30. In an implementation, the second width L2 of the second portion 62 may be larger than the first width L1 of the first portion 61.

Referring back to FIGS. 3 and 4, an edge of a surface of the second portion 62 facing the electrode assembly 10 may include an inclined surface. In an implementation, as illustrated in FIG. 4, the inclined surface of the edge of the surface of the second portion 62 may include a rounded-inclined surface 62a.

The second portion 62 may contact all of, e.g., all four of, the stacked electrode assemblies 10 during a test (e.g., a drop test) for measuring durability of the rechargeable battery 100 and/or when the electrode assembly 10 is expanded by gas generated from the inside thereof due to charging/recharging. Accordingly, deformation of the electrode assembly 10 may be minimized by reducing stress applied to each individual electrode assembly 10. In addition, even if the electrode assembly 10 were to contact the round-inclined surface 62a of the second portion 62, damage to the electrode assembly 10 may be prevented.

The second portion 62 may have an insulation function to prevent current flow between the cap plate 30 and the electrode assembly 10, and may prevent the electrode assembly 10 from being deformed by absorbing external impact applied to the electrode assembly 10 at a part thereof corresponding to the second portion 62.

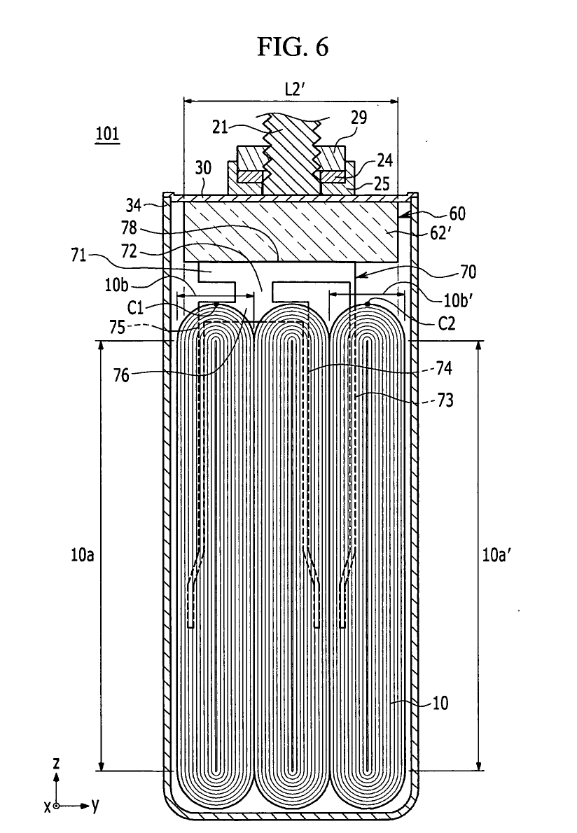

FIG. 6 illustrates a cross-sectional view of a modified example of the rechargeable battery of FIG. 1.

Referring to FIG. 6, the rechargeable battery 101 according to the present modified example has the same structure as the rechargeable battery 100 of FIG. 1 except for a first electrode current collecting member 70. Therefore, a repeated description of the same structure will be omitted.

Referring to FIG. 6, the current collecting member 70 according to the present example may include a terminal junction portion 78 attached to a terminal by welding and a plurality of tab branches 73, 74, and 75 that extend below the terminal junction portion 78 and are inserted between the electrode assemblies 10.

The rechargeable battery 101 according to the present example may include a plurality of electrode assemblies, e.g., three electrode assemblies 10 and the three electrode assemblies 10 may be stacked and arranged in parallel.

The terminal junction portion 78 may be parallel to the cap plate 30 and fixed, e.g., welded to a bottom of the terminal. The tab branches 73, 74, and 75 may include a first tab branch 73, a second tab branch 74, and a third tab branch 75, the three tab branches 73, 74, and 75 being arranged in parallel to one another. A first basin portion 71 protruding outwardly further than a side end of the terminal junction portion 78 may be below the terminal junction portion 78. Accordingly, the first basin portion 71 may be bent toward the bottom of the case 34 from the terminal junction portion 78.

The first tab branch 73 may be bent on one side end of the first basin portion 71. The first tab branch 73 may be bent at a right angle on the side end of the first basin portion 71 and may be parallel to a wide front surface of the electrode assembly 10.

The current collecting member 70 may include connection plate 72 that extends downwardly toward the bottom of the case 34 and below the first basin portion 71 as well as a second basin portion 76 protruding further outwardly than the side end of the connection plate 72 below the connection plate 72. The second tab branch 74 and the third tab branch 75 may be on side ends of the second basin portion 76. The second tab branch 74 and the third tab branch 75 may be bent at a right angle to be parallel to a wide front surface of one of the electrode assemblies 10 at the second basin portion 76 and may extend toward the bottom of the electrode assembly 10 from the second basin portion 76.

The three electrode assemblies 10 may overlap with or may be stacked against each other; and a separated space may be between the positive uncoated regions 11a. Thus, two separated spaces may be formed. The first tab branch 73 and the second tab branch 74 may be inserted into one separated space and the third tab branch 75 may be joined on an outer surface of the positive uncoated region 11a of the electrode assembly 10 on an outside of the stack.

In an implementation, a second portion 62′ of the lower insulating member 60 may have a second width L2′. Thus, width-direction ends of the second portion 62′ may lie in a plane between an inner surface of the case 34 and centers C1 and C2 of top surfaces of outermost electrode assemblies 10 of the stack, e.g., surfaces facing the second portion.

For example, the width-direction ends of the second portion 62′ may lie in a plane between side surfaces 10a and 10′a of the outermost electrode assemblies 10 and the centers C1 and C2 of curved, e.g., top, surfaces 10b and 10′b of the outermost electrode assemblies 10. In an implementation, the second width L2′ may be equal to the width of the cap plate 30.

In an implementation, the second width L2′ of the second portion 62′ may be larger than a first width L1′ (not shown) of the first portion 61.

An edge of a surface of the second portion 62′ facing the electrode assemblies 10 may include an inclined surface (not shown). For example, the inclined surface of the edge of the second portion 62′ may include a rounded-inclined surface.

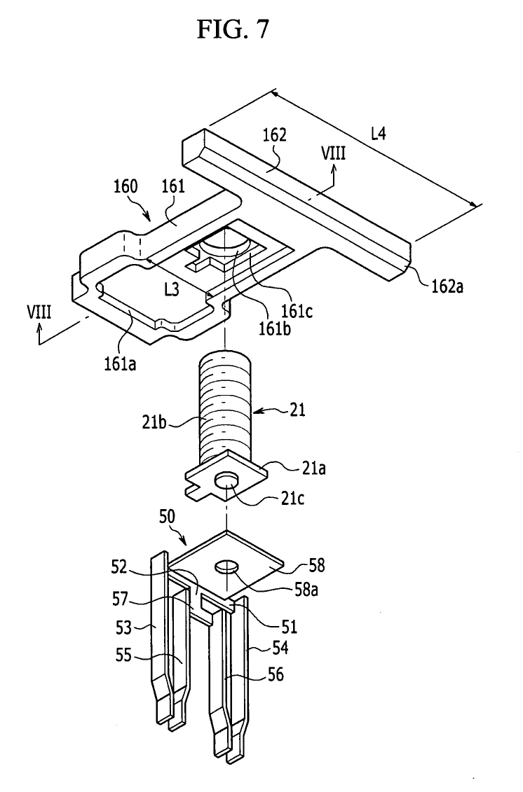

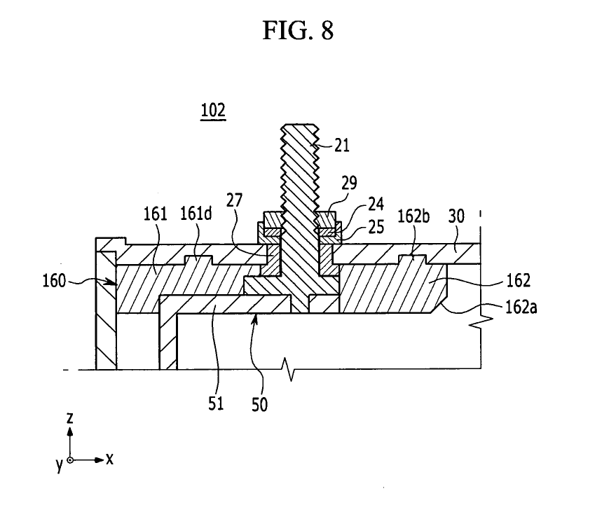

FIG. 7 illustrates a partial exploded perspective view of a rechargeable battery according to another embodiment. FIG. 8 is a cross-sectional view taken along line VIII-VIII of FIG. 7.

Referring to FIGS. 7 and 8, the rechargeable battery 102 according to the present embodiment has the same structure as the rechargeable battery 100 according to the previous embodiment except for a lower insulating member 160. Therefore, repeated descriptions of the same structure will be omitted. Further, widths L3 and L4 of the lower insulating member 160 according to the present embodiment are equal to the widths L1 and L2 described with respect to the previous embodiment. Therefore, a repeated description of the widths L3 and L3 will be omitted.

Referring to FIGS. 7 and 8, the lower insulating member 160 may include a first portion 161 fixed to the first electrode terminal 21. The lower insulating member 160 may have the third width L3 in the direction parallel to the surface of the cap plate 30. Further, the lower insulating member 160 may include a second portion 162 that extends from the first portion 161 and has the fourth width L4 in the direction parallel to the cap plate 30.

Further, as shown in FIG. 7, the lower insulating member 160 may include a terminal hole 161b at a portion, e.g., right side, thereof, a flange groove 161c to which the terminal flange 21a may be fixed, and a junction groove 161a into which the first current collecting member 50 may be inserted.

As illustrated in FIG. 8, a first fixation protrusion 161d and a second fixation protrusion 162b for preventing the lower insulating member 160 from being rotated may be on surfaces of the first portion 161 and the second portion 162, respectively, facing the cap plate 30 and may be coupled to fixation grooves in the cap plate 30.

An edge of the surface of the second portion 162 facing the electrode assembly 10 may include an inclined surface. In an implementation, as illustrated in FIGS. 7 and 8, the inclined surface of the edge of the second portion 162 may include a flat-inclined surface 162a.

The second portion 162 may contact all of the plurality of stacked electrode assemblies 10 during a test (e.g., a drop test) for measuring the durability of the rechargeable battery 102 and/or when the electrode assembly 10 is expanded by gas generated from the inside thereof by charging/discharging. Accordingly, deformation of the electrode assembly 10 may be minimized by reducing stress applied to each electrode assembly 10. In addition, even if the electrode assembly 10 contacts the flat-inclined surface of the second portion 162, damage to the electrode assembly 10 may be prevented.

The second portion 162 may have an insulation function to prevent current flow between the cap plate 30 and the electrode assembly 10 and may prevent the electrode assembly 10 from being deformed by absorbing external impact applied to the electrode assembly 10 in a part corresponding to the second portion 162.

By way of review, in a rechargeable battery, an electrode assembly wound in a jelly roll shape may be deformed by external impact or an increase in internal pressure, which may be caused by generation of gas in the rechargeable battery while the rechargeable battery is repeatedly charged and discharged. The deformed electrode assembly may be prevented from contacting a case by an insulating member that performs an insulation function between the case and the electrode assembly of the rechargeable battery.

According to the embodiments, even if some of the deformed electrode assemblies contact the insulating member, a concentration of stress on electrode assemblies that do not contact the insulating member may be prevented.

According to the embodiments, even if the electrode assembly contacts an edge portion of the insulating member, damage to the electrode assembly may be prevented.

Thus, the embodiments provide a rechargeable battery including an insulating member capable of preventing stress from concentrating on electrode assemblies deformed due to external impact or an increase in internal pressure and preventing the electrode assemblies from being damaged.

The embodiments provide a rechargeable battery having an improved structure of a lower insulating member.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A rechargeable battery, comprising:
a plurality of electrode assemblies;
a case accommodating the plurality of electrode assemblies, the case having an opening;
a cap assembly coupled to the opening to seal the case;
one or more electrode terminals electrically connected to the electrode assemblies; and
a lower insulating member coupled to the one or more electrode terminals and installed in the case, wherein:
the lower insulating member includes:
a first portion fixed to the electrode terminal, the first portion having a first width, and
a second portion extending from one end of the first portion, the second portion having a second width, and
a width-direction end of the second portion lies in a plane between an inner surface of the case and a center of a top surface of an outermost electrode assembly among the electrode assemblies, the top surface facing the second portion.

2. The rechargeable battery as claimed in claim 1, wherein the top surface of the electrode assembly facing the second portion of the lower insulating member includes a curved portion.

3. The rechargeable battery as claimed in claim 1, wherein the second width of the second portion is about equal to a width of the cap plate.

4. The rechargeable battery as claimed in claim 1, wherein the second width of the second portion is larger than the first width.

5. The rechargeable battery as claimed in claim 1, wherein the second portion includes an edge facing the electrode assembly, the edge including an inclined surface.

6. The rechargeable battery as claimed in claim 5, wherein: the inclined surface of the edge of the second portion is a rounded-inclined surface.

7. The rechargeable battery as claimed in claim 5, wherein the inclined surface of the edge of the second portion is a flat-inclined surface.

8. The rechargeable battery as claimed in claim 1, wherein the lower insulating member includes:
a first fixation protrusion on a surface of the first portion, the first fixation protrusion facing the cap assembly; and
a second fixation protrusion on a surface of the second portion, the second fixation protrusion facing the cap assembly.

9. The rechargeable battery as claimed in claim 1, further comprising a protection member covering a portion of an outside of the electrode assembly, the portion of the outside of the electrode assembly corresponding to the lower insulating member.

10. The rechargeable battery as claimed in claim 9, wherein the protection member is a tape covering the outside of the electrode assembly.

11. The rechargeable battery as claimed in claim 1, wherein the lower insulating member is made of an elastic material.

12. The rechargeable battery as claimed in claim 1, wherein the one or more electrode terminals is electrically connected to the electrode assemblies through an electrode current collecting member.

13. The rechargeable battery as claimed in claim 12, wherein the electrode current collecting member includes a terminal junction portion, the terminal junction portion being electrically connected to the one or more electrode terminals.

14. The rechargeable battery as claimed in claim 13, wherein the electrode current collecting member includes at least one tab branch, the at least one tab branch being electrically connected to at least one of the plurality of electrode assemblies and the terminal junction portion.
